(19) United States
(12) Patent Application Publication
(10) Pub. No.: US 2025/0236115 A1
(43) Pub. Date: Jul. 24, 2025

(54) IMAGE FORMING SYSTEM CAPABLE OF SUPPRESSING VARIATION OF INK DISCHARGE AMOUNTS IN PLURALITY OF DISCHARGE ELEMENTS, AND ADJUSTMENT METHOD

(71) Applicant: KYOCERA Document Solutions Inc., Osaka (JP)

(72) Inventors: Naoki Sekioka, Osaka (JP); Naoko Kawashima, Osaka (JP)

(21) Appl. No.: 19/024,263

(22) Filed: Jan. 16, 2025

(30) Foreign Application Priority Data
Jan. 23, 2024 (JP) 2024-007886
Mar. 21, 2024 (JP) 2024-044385

(51) Int. Cl. B41J 2/21; B41J 29/393; H04N 1/23; H04N 1/60

(52) U.S. Cl. CPC B41J 2/2128; B41J 29/393; H04N 1/2338; H04N 1/2346; H04N 1/6044; B41J 2029/3935

(57) ABSTRACT

An image forming system includes a plurality of nozzles, discharge elements, an image forming processing portion, a reading processing portion, and an adjustment processing portion. The plurality of nozzles are arranged along a width direction orthogonal to a conveying direction of a sheet. The discharge elements are respectively provided in correspondence with the nozzles and cause ink to be discharged from the nozzles in accordance with an application of a driving voltage. The image forming processing portion forms an adjustment image that is based on adjustment image data on the conveyed sheet. The reading processing portion reads the adjustment image formed on the sheet. The adjustment processing portion adjusts the driving voltage for each of the discharge elements or in a unit of the plurality of discharge elements based on the read adjustment image.

### INCORPORATION BY REFERENCE

This application is based upon and claims the benefit of priority from the corresponding Japanese Patent Application No. 2024-007886 filed on Jan. 23, 2024, and 2024-044385 filed on Mar. 21, 2024, the entire contents of which are incorporated herein by reference.

### BACKGROUND

The present disclosure relates to an image forming system and an adjustment method.

There is known an image forming apparatus capable of forming an image on a sheet using an inkjet system. This type of image forming apparatus includes a sheet conveying portion, a plurality of nozzles, and discharge elements respectively provided in correspondence with the nozzles. The sheet conveying portion conveys the sheet. The plurality of nozzles are arranged along a width direction orthogonal to a conveying direction of the sheet by the sheet conveying portion. The discharge elements cause ink to be discharged from the nozzles in accordance with an application of a preset driving voltage.

### SUMMARY

An image forming system according to an aspect of the present disclosure includes a sheet conveying portion, a plurality of nozzles, discharge elements, an image forming processing portion, a reading processing portion, and an adjustment processing portion. The sheet conveying portion conveys a sheet. The plurality of nozzles are arranged along a width direction orthogonal to a conveying direction of the sheet by the sheet conveying portion. The discharge elements are respectively provided in correspondence with the nozzles and cause ink to be discharged from the nozzles in accordance with an application of a driving voltage. The image forming processing portion forms, using a plurality of the discharge elements, an adjustment image that is based on predetermined adjustment image data on the sheet conveyed by the sheet conveying portion. The reading processing portion reads the adjustment image formed on the sheet. The adjustment processing portion adjusts the driving voltage for each of the discharge elements or in a unit of the plurality of discharge elements based on the adjustment image read by the reading processing portion.

An adjustment method according to another aspect of the present disclosure is executed in an image forming system including a sheet conveying portion which conveys a sheet, a plurality of nozzles arranged along a width direction orthogonal to a conveying direction of the sheet by the sheet conveying portion, and discharge elements which are respectively provided in correspondence with the nozzles and cause ink to be discharged from the nozzles in accordance with an application of a driving voltage, and includes an image forming step, a reading step, and an adjustment step. The image forming step includes forming, using a plurality of the discharge elements, an adjustment image that is based on predetermined adjustment image data on the sheet conveyed by the sheet conveying portion. The reading step includes reading the adjustment image formed on the sheet. The adjustment step includes adjusting the driving voltage for each of the discharge elements or in a unit of the plurality of discharge elements based on the adjustment image read in the reading step.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a configuration of an image forming system according to a first embodiment of the present disclosure;

FIG. 2 is a block diagram showing a configuration of an image forming apparatus in the image forming system according to the first embodiment of the present disclosure;

FIG. 3 is a cross-sectional view showing the configuration of the image forming apparatus in the image forming system according to the first embodiment of the present disclosure;

FIG. 4 is a plan view showing configurations of an image forming portion and a conveying unit in the image forming system according to the first embodiment of the present disclosure;

FIG. 5 is a cross-sectional view showing a configuration in a periphery of nozzles in the image forming system according to the first embodiment of the present disclosure;

FIG. 6 is a block diagram showing a configuration of an information processing apparatus in the image forming system according to the first embodiment of the present disclosure;

FIG. 7 is a flowchart showing an example of first driving voltage adjustment processing executed in the image forming system according to the first embodiment of the present disclosure;

FIG. 8 is a block diagram showing a configuration of an image forming system according to a second embodiment of the present disclosure;

FIG. 9 is a block diagram showing a configuration of an image forming apparatus in the image forming system according to the second embodiment of the present disclosure;

FIG. 10 is a block diagram showing a configuration of an information processing apparatus in the image forming system according to the second embodiment of the present disclosure;

FIG. 11 is a flowchart showing an example of second driving voltage adjustment processing executed in the image forming system according to the second embodiment of the present disclosure; and

FIG. 12 is a diagram showing an example of a manual adjustment image formed by the image forming system according to the second embodiment of the present disclosure.

### DETAILED DESCRIPTION

Hereinafter, embodiments of the present disclosure will be described with reference to the attached drawings. It is noted that the following embodiments are each an example of embodying the present disclosure and do not limit the technical scope of the present disclosure.

### First Embodiment

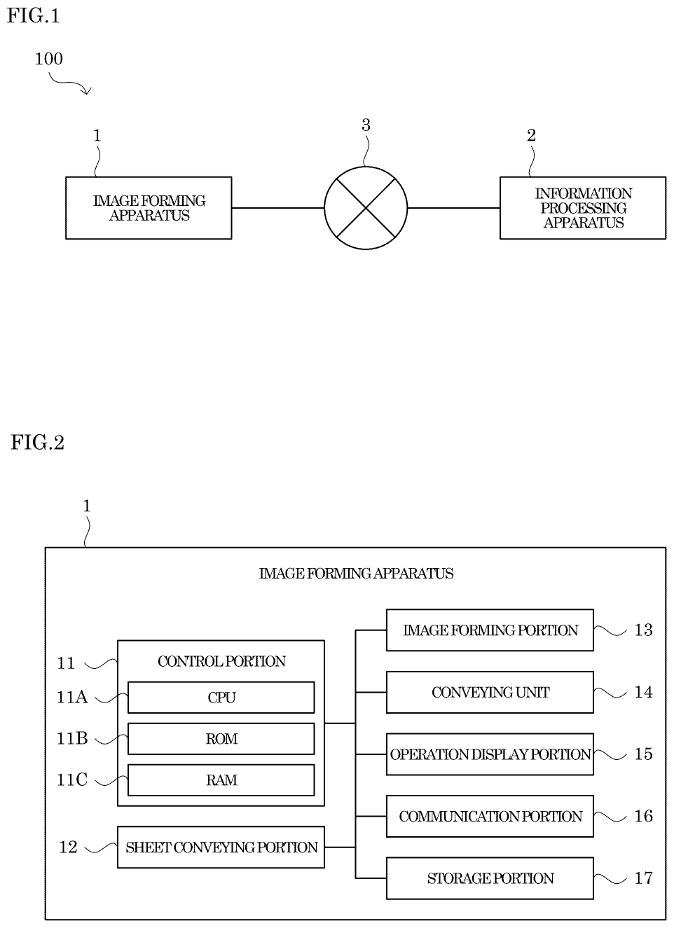

First, a configuration of an image forming system 100 according to a first embodiment of the present disclosure will be described with reference to FIG. 1.

As shown in FIG. 1, the image forming system 100 includes an image forming apparatus 1 and an information processing apparatus 2. In the image forming system 100, the image forming apparatus 1 and the information processing apparatus 2 are communicably connected to each other via a communication network 3. For example, the communication network 3 is the Internet or a LAN (Local Area Network). It is noted that the image forming system 100 may include a plurality of image forming apparatuses 1.

### Configuration of Image Forming Apparatus 1

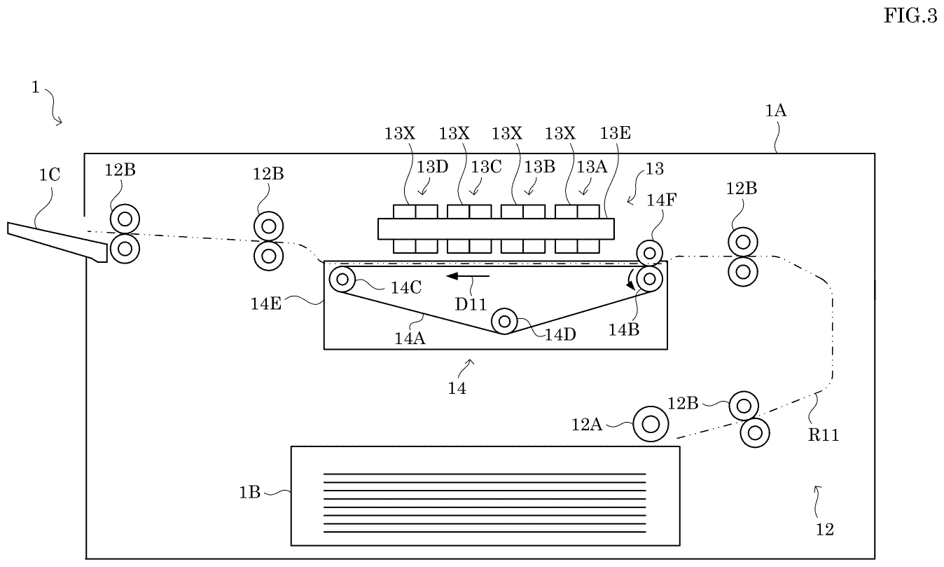

Next, a configuration of the image forming apparatus 1 will be described with reference to FIG. 2 to FIG. 5. It is noted that in FIG. 3, a sheet conveying path R11 is indicated by a dash-dot-dot line.

The image forming apparatus 1 is a printer that is capable of forming an image on a sheet using an inkjet system. It is noted that the image forming apparatus 1 may alternatively be a facsimile apparatus, a copying machine, a multifunction peripheral, or the like that is capable of forming an image on a sheet using the inkjet system.

As shown in FIG. 2, the image forming apparatus 1 includes a control portion 11, a sheet conveying portion 12, an image forming portion 13, a conveying unit 14, an operation display portion 15, a communication portion 16, and a storage portion 17. Further, the image forming apparatus 1 includes a housing 1A shown in FIG. 3.

The housing 1A accommodates respective constituent elements of the image forming apparatus 1. A sheet feed cassette 1B is detachably provided in the housing 1A. The sheet feed cassette 1B stores sheets on each of which an image is to be formed. A sheet discharge tray 1C is provided on an outer side surface of the housing 1A. A sheet on which an image has been formed by the image forming portion 13 is discharged onto the sheet discharge tray 1C. Inside the housing 1A, the sheet stored in the sheet feed cassette 1B is conveyed along the sheet conveying path R11 (see FIG. 3) that reaches the sheet discharge tray 1C via an image forming position of the image forming portion 13.

The control portion 11 collectively controls the image forming apparatus 1. As shown in FIG. 2, the control portion 11 includes a CPU 11A, a ROM 11B, and a RAM 11C. The CPU 11A is a processor that executes various types of arithmetic processing. The ROM 11B is a nonvolatile storage device in which information such as control programs for causing the CPU 11A to execute various types of processing is stored in advance. The RAM 11C is a volatile or nonvolatile storage device that is used as a temporary storage memory (working area) for the various type of processing to be executed by the CPU 11A. The CPU 11A executes the various control programs stored in advance in the ROM 11B. Thus, the CPU 11A collectively controls the image forming apparatus 1.

The sheet conveying portion 12 conveys the sheet stored in the sheet feed cassette 1B along the sheet conveying path R11 (see FIG. 3). As shown in FIG. 3, the sheet conveying portion 12 includes a pickup roller 12A and a plurality of conveying rollers 12B. The pickup roller 12A takes out an uppermost sheet out of a batch of sheets stored in the sheet feed cassette 1B, and feeds the sheet to the sheet conveying path R11. The plurality of conveying rollers 12B are provided so as to be aligned along the sheet conveying path R11. Each of the conveying rollers 12B conveys the sheet along the sheet conveying path R11. Each of the conveying rollers 12B conveys the sheet in a conveying direction D11 (see FIG. 3) that is directed from the sheet feed cassette 1B toward the sheet discharge tray 1C.

The image forming portion 13 forms an image that is based on image data on the sheet supplied from the sheet conveying portion 12. As shown in FIG. 3, the image forming portion 13 includes line heads 13A to 13D and a head frame 13E.

As shown in FIG. 4, each of the line heads 13A to 13D is elongated in a width direction D12 orthogonal to the conveying direction D11 of the sheet by the sheet conveying portion 12. Specifically, each of the line heads 13A to 13D has, in the width direction D12, a length corresponding to a width of a sheet of a maximum size out of the sheets that can be stored in the sheet feed cassette 1B. The line heads 13A to 13D are provided so as to be aligned at regular intervals along the conveying direction D11.

The line head 13A discharges black ink toward the sheet conveyed by the conveying unit 14. The line head 13B discharges cyan ink toward the sheet conveyed by the conveying unit 14. The line head 13C discharges magenta ink toward the sheet conveyed by the conveying unit 14. The line head 13D discharges yellow ink toward the sheet conveyed by the conveying unit 14.

The line heads 13B to 13D have a common configuration with the line head 13A except that the colors of the ink to be discharged differ. Hereinafter, descriptions will be given only on the line head 13A.

As shown in FIG. 4, the line head 13A includes three recording heads 13X. Each of the recording heads 13X is elongated in the width direction D12. The three recording heads 13X are arranged in a staggered pattern along the width direction D12.

A plurality of nozzles 13F (see FIG. 4) are provided on an opposing surface of each of the recording heads 13X that opposes the sheet. In each of the recording heads 13X, the plurality of nozzles 13F are arranged along the width direction D12. Specifically, in each of the recording heads 13X, the plurality of nozzles 13F are arranged along the width direction D12 at a density corresponding to a printing resolution of the image forming apparatus 1. For example, the plurality of nozzles 13F are arranged so as to be aligned at regular intervals along the width direction D12. In other words, each of the recording heads 13X includes a nozzle row formed by the plurality of nozzles 13F aligned at regular intervals along the width direction D12. It is noted that each of the recording heads 13X may include a plurality of nozzle rows. In this case, the nozzle rows are arranged such that positions thereof in the width direction D12 are deviated from each other.

All of the nozzles 13F included in the line head 13A are arranged along the width direction D12. Specifically, the three recording heads 13X included in the line head 13A are arranged in a staggered pattern along the width direction D12 such that all of the nozzles 13F included in the line head 13A are arranged along the width direction D12 at the density corresponding to the printing resolution of the image forming apparatus 1. The plurality of nozzles 13F included in the line head 13A are an example of a plurality of nozzles according to the present disclosure.

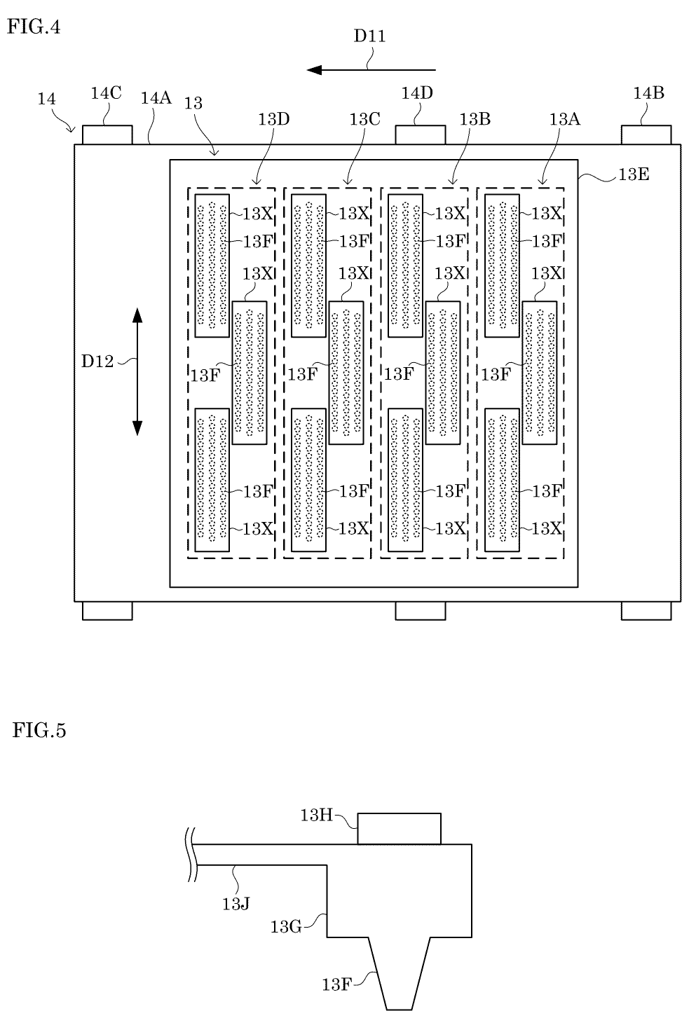

Each of the recording heads 13X includes pressurization chambers 13G (see FIG. 5), discharge elements 13H (see FIG. 5), and individual flow paths 13J (see FIG. 5) that respectively correspond to the nozzles 13F. The pressurization chamber 13G is in communication with the nozzle 13F and stores ink. The discharge element 13H causes the ink to be discharged from the nozzle 13F in accordance with an application of a driving voltage. The discharge element 13H is a piezoelectric element. Specifically, a driving signal including an ON state where the driving voltage is applied and an OFF state where the driving voltage is not applied is input to the discharge element 13H. The discharge element 13H varies a pressure of the pressurization chamber 13G in accordance with the input of the driving signal, to thus cause the ink to be discharged from the nozzle 13F. The individual flow path 13J is an ink flow path provided between the pressurization chamber 13G and a common flow path (not shown) common to the plurality of nozzles 13F. A plurality of individual flow paths 13J respectively corresponding to the plurality of nozzles 13F are connected to the common flow path. The common flow path is connected to an ink supplying portion (not shown) that supplies the ink to each of the pressurization chambers 13G. It is noted that the discharge element 13H may alternatively be a thermoelectric element or the like.

Further, each of the recording heads 13X includes power supplies (not shown) that respectively correspond to groups each constituted of some of the plurality of discharge elements 13H included in the recording head 13X. Specifically, the group is constituted of a plurality of discharge elements 13H corresponding to a predetermined number of nozzles 13F that are consecutive along the width direction D12. Each of the power supplies generates the driving voltage to be applied to each of the discharge elements 13H included in the group. Furthermore, each of the power supplies has a function of adjusting a voltage value of the driving voltage. Thus, in the image forming apparatus 1, the voltage value of the driving voltage can be adjusted for each of the groups. It is noted that the number of discharge elements 13H to be included in the group may differ for each of the groups.

Moreover, each of the recording heads 13X includes driving circuits (not shown) that respectively correspond to the discharge elements 13H. The driving circuit generates the driving signal based on print data generated based on print target image data and the driving voltage output from the power supply.

The head frame 13E supports the line heads 13A to 13D. The head frame 13E is supported by the housing 1A. It is noted that the number of line heads to be provided in the image forming portion 13 only needs to be one or more. Further, the number of recording heads 13X to be provided in each of the line heads 13A to 13D does not need to be limited to three.

As shown in FIG. 3, the conveying unit 14 is arranged below the line heads 13A to 13D. The conveying unit 14 conveys the sheet while causing the sheet to oppose the recording heads 13X. For example, the conveying unit 14 conveys the sheet by a predetermined conveying amount every time the discharge of the ink is performed by the recording head 13X. Further, while the discharge of the ink is performed by the recording head 13X, the conveying unit 14 stops the conveyance of the sheet. As shown in FIG. 3, the conveying unit 14 includes a conveying belt 14A on which a sheet is placed, a first tension roller 14B, a second tension roller 14C, and a third tension roller 14D across which the conveying belt 14A is stretched, and a conveying frame 14E that supports these. It is noted that a gap between the conveying belt 14A and the recording heads 13X is adjusted such that a gap between a sheet surface and the recording heads 13X during image formation becomes a predetermined distance (for example, 1 mm).

The first tension roller 14B is rotationally driven by a rotational driving force supplied from a motor (not shown). Thus, the conveying belt 14A rotates in a direction in which the sheet can be conveyed in the conveying direction D11 (see FIG. 3). It is noted that the conveying unit 14 is also provided with a suction unit (not shown) or the like that sucks in air via a large number of through-holes formed in the conveying belt 14A to cause the sheet to stick to the conveying belt 14A. Further, a pressure roller 14F for conveying the sheet while pressing the sheet against the conveying belt 14A is provided above the first tension roller 14B.

The operation display portion 15 is a user interface of the image forming apparatus 1. The operation display portion 15 includes a first display portion and a first operation portion. The first display portion displays various types of information in response to control instructions from the control portion 11. For example, the first display portion is a flat panel display such as a liquid crystal display. The first operation portion is used to input various types of information to the control portion 11 in accordance with operations of a user. For example, the first operation portion includes an operation key and a touch panel.

The communication portion 16 is a communication interface for executing wired or wireless data communication with an external communication apparatus such as the information processing apparatus 2 via the communication network 3.

The storage portion 17 is a nonvolatile storage device. For example, the storage portion 17 is a nonvolatile memory such as a flash memory. It is noted that the storage portion 17 may alternatively be a storage device such as an SSD (Solid State Drive) and an HDD (Hard Disk Drive).

### Configuration of Information Processing Apparatus 2

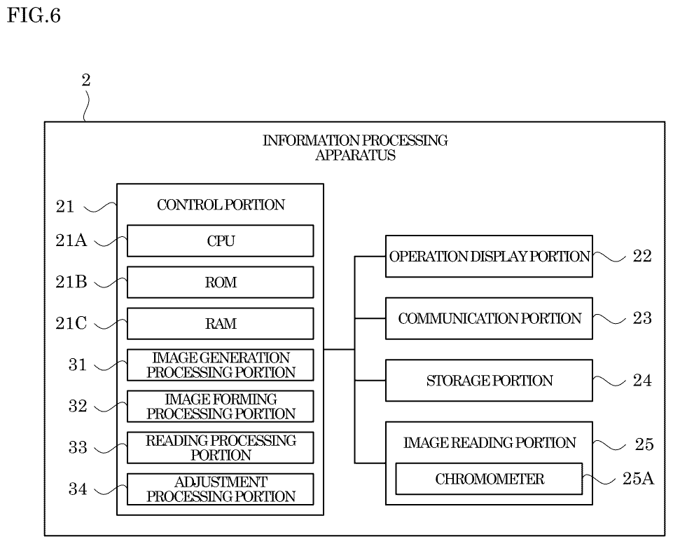

Next, a configuration of the information processing apparatus 2 will be described with reference to FIG. 6.

As shown in FIG. 6, the information processing apparatus 2 includes a control portion 21, an operation display portion 22, a communication portion 23, a storage portion 24, and an image reading portion 25.

The control portion 21 collectively controls the information processing apparatus 2. As shown in FIG. 6, the control portion 21 includes a CPU 21A, a ROM 21B, and a RAM 21C. The CPU 21A, the ROM 21B, and the RAM 21C have functions similar to those of the CPU 11A, the ROM 11B, and the RAM 11C of the image forming apparatus 1.

The operation display portion 22 is a user interface of the information processing apparatus 2. The operation display portion 22 includes a second display portion and a second operation portion. The second display portion displays various types of information in response to control instructions from the control portion 21. For example, the second display portion is a flat panel display such as a liquid crystal display. The second operation portion is used to input various types of information to the control portion 21 in accordance with operations of the user. For example, the second operation portion includes a keyboard, a mouse, and a touch panel.

The communication portion 23 is a communication interface for executing wired or wireless data communication with an external communication apparatus such as the image forming apparatus 1 via the communication network 3.

The storage portion 24 is a nonvolatile storage device similar to the storage portion 17 of the image forming apparatus 1.

The image reading portion 25 is capable of reading an image formed on a sheet by the image forming apparatus 1. Specifically, the image reading portion 25 includes a chromometer 25A shown in FIG. 6. In addition, the image reading portion 25 includes a sheet placing portion (not shown), a conveying portion (not shown), a sheet discharge portion (not shown), and a chromometer supporting portion (not shown). The conveying portion conveys a sheet placed on the sheet placing portion to the sheet discharge portion. The chromometer supporting portion is provided on a conveying path of the sheet conveyed by the conveying portion and supports the chromometer 25A on an upper side of the sheet conveyed by the conveying portion. Further, the chromometer supporting portion is provided to be movable in a direction orthogonal to the conveying direction of the sheet by the conveying portion. In other words, the chromometer 25A is provided to be movable in the direction orthogonal to the conveying direction of the sheet on the upper side of the sheet conveyed by the conveying portion. The chromometer 25A measures colors of an image on the sheet conveyed by the conveying portion, and outputs a value indicating a color of a color measurement target. For example, the chromometer 25A outputs a Lab value defined by CIE (International Commission on Illumination). It is noted that the image reading portion 25 may include a CIS (Contact Image Sensor) in place of the chromometer 25A.

Incidentally, in the image forming apparatus 1, ink discharge amounts may vary in the plurality of discharge elements 13H included in the line head 13A due to individual errors of the discharge elements 13H and the like. However, conventionally, there has not been a configuration with which the variation of the ink discharge amounts in the plurality of discharge elements 13H included in the line head 13A can be suppressed.

In contrast, in the image forming system 100 according to the first embodiment of the present disclosure, it is possible to suppress the variation of the ink discharge amounts in the plurality of discharge elements 13H included in the line head 13A as will be described below.

Specifically, a driving voltage adjustment program for causing the control portion 21 to function as an image generation processing portion 31, an image forming processing portion 32, a reading processing portion 33, and an adjustment processing portion 34 shown in FIG. 6 is stored in advance in the storage portion 24 of the information processing apparatus 2. The CPU 21A of the control portion 21 executes the driving voltage adjustment program to thus function as the respective processing portions described above.

It is noted that some or all of the processing portions included in the control portion 21 of the information processing apparatus 2 may be constituted of an electronic circuit. Further, the driving voltage adjustment program may be a program for causing a plurality of processors to function as the respective processing portions shown in FIG. 6.

The image generation processing portion 31 executes rasterization processing to generate predetermined adjustment image data.

Herein, the adjustment image data is image data in a bitmap format for forming an adjustment image on a sheet conveyed by the sheet conveying portion 12 of the image forming apparatus 1. For example, the adjustment image includes four monochrome images respectively corresponding to four colors of black, cyan, magenta, and yellow. The monochrome images are each a strip-like image that is elongated in the width direction D12. Each of the monochrome images is formed by using all of the nozzles 13F included in the line head corresponding to the color of the monochrome image.

For example, original image data in a vector format which is used for generating the adjustment image data is stored in advance in the storage portion 24 of the information processing apparatus 2.

The image generation processing portion 31 executes the rasterization processing on the original image data, to thus generate the adjustment image data.

Using the line heads 13A to 13D, the image forming processing portion 32 forms the adjustment image that is based on the adjustment image data on the sheet conveyed by the sheet conveying portion 12.

Specifically, using the plurality of discharge elements 13H included in the line head 13A, the image forming processing portion 32 forms the monochrome image of black (an example of an adjustment image according to the present disclosure) on the sheet conveyed by the sheet conveying portion 12.

Further, using the plurality of discharge elements 13H included in the line head 13B, the image forming processing portion 32 forms the monochrome image of cyan on the sheet conveyed by the sheet conveying portion 12.

Further, using the plurality of discharge elements 13H included in the line head 13C, the image forming processing portion 32 forms the monochrome image of magenta on the sheet conveyed by the sheet conveying portion 12.

Further, using the plurality of discharge elements 13H included in the line head 13D, the image forming processing portion 32 forms the monochrome image of yellow on the sheet conveyed by the sheet conveying portion 12.

For example, the image forming processing portion 32 causes the control portion 11 of the image forming apparatus 1 to execute setting processing before forming the adjustment image. The setting processing is processing of setting the voltage value of the driving voltage of all of the discharge elements 13H included in the image forming portion 13 to a predetermined reference value.

Then, after the execution of the setting processing, the image forming processing portion 32 transmits the adjustment image data to the image forming apparatus 1, and causes the control portion 11 of the image forming apparatus 1 to execute adjustment image forming processing. The adjustment image forming processing is processing of forming the adjustment image on the sheet conveyed by the sheet conveying portion 12.

The reading processing portion 33 reads the adjustment image formed on the sheet.

Specifically, the reading processing portion 33 reads the color of each of the monochrome images included in the adjustment image formed on the sheet using the chromometer 25A.

For example, after the execution of the adjustment image forming processing, the reading processing portion 33 causes the operation display portion 22 to display an acceptance screen. The acceptance screen is a screen for accepting a reading operation that instructs execution of reading processing for reading a color of an image on a sheet placed on the sheet placing portion using the image reading portion 25.

Then, the reading processing portion 33 executes the reading processing when the reading operation is accepted in the acceptance screen.

For example, in the reading processing, the color of each of the monochrome images included in the adjustment image formed on the sheet is read using the chromometer 25A. Herein, in the reading processing, for each of sectional areas included in the monochrome image, the color of the sectional area is read. The sectional area is an area formed by the plurality of discharge elements 13H constituting the group.

The adjustment processing portion 34 adjusts the driving voltage in a unit of the plurality of discharge elements 13H based on the adjustment image read by the reading processing portion 33.

Specifically, the adjustment processing portion 34 adjusts the driving voltage in a unit of the plurality of discharge elements 13H constituting the group.

For example, the adjustment processing portion 34 transmits an execution result of the reading processing to the image forming apparatus 1, and causes the control portion 11 of the image forming apparatus 1 to execute adjustment processing. The adjustment processing is processing of adjusting the driving voltage in a unit of the plurality of discharge elements 13H constituting the group.

Specifically, in the adjustment processing, a color difference between a color reading result of the sectional area formed by the plurality of discharge elements 13H constituting the group and a predetermined first reference color is calculated for each of the groups included in the line head 13A. Then, the driving voltage of each of the groups is adjusted based on the color difference calculated for each of the groups.

Further, in the adjustment processing, a color difference between a color reading result of the sectional area formed by the plurality of discharge elements 13H constituting the group and a predetermined second reference color is calculated for each of the groups included in the line head 13B. Then, the driving voltage of each of the groups is adjusted based on the color difference calculated for each of the groups.

Further, in the adjustment processing, a color difference between a color reading result of the sectional area formed by the plurality of discharge elements 13H constituting the group and a predetermined third reference color is calculated for each of the groups included in the line head 13C. Then, the driving voltage of each of the groups is adjusted based on the color difference calculated for each of the groups.

Further, in the adjustment processing, a color difference between a color reading result of the sectional area formed by the plurality of discharge elements 13H constituting the group and a predetermined fourth reference color is calculated for each of the groups included in the line head 13D. Then, the driving voltage of each of the groups is adjusted based on the color difference calculated for each of the groups.

### First Driving Voltage Adjustment Processing

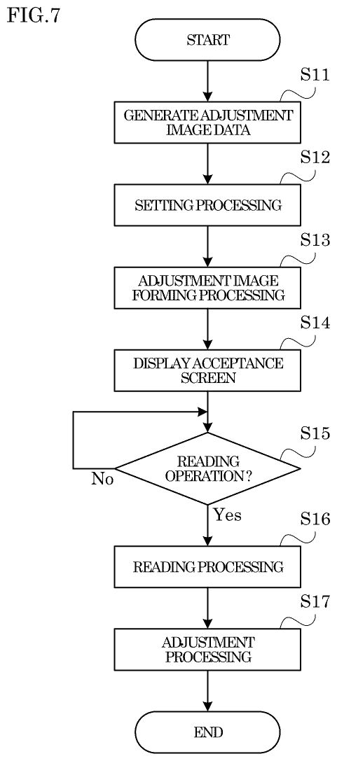

Hereinafter, with reference to FIG. 7, an adjustment method according to the present disclosure will be described along with exemplary procedures of first driving voltage adjustment processing executed by the control portion 21 of the information processing apparatus 2 in the image forming system 100. Herein, Step S11, Step S12, . . . represent numbers of processing procedures (steps) executed by the control portion 21. For example, the first driving voltage adjustment processing is executed when an operation that instructs execution of the first driving voltage adjustment processing is accepted in the operation display portion 22.

### <Step S11>

First, in Step S11, the control portion 21 generates the adjustment image data. The processing of Step S11 is executed by the image generation processing portion 31 of the control portion 21.

Specifically, the control portion 21 generates the adjustment image data by executing the rasterization processing on the original image data.

### <Step S12>

In Step S12, the control portion 21 causes the control portion 11 of the image forming apparatus 1 to execute the setting processing.

### <Step S13>

In Step S13, the control portion 21 transmits the adjustment image data to the image forming apparatus 1, and causes the control portion 11 of the image forming apparatus 1 to execute the adjustment image forming processing. The processing of Step S12 and Step S13 is an example of an image forming step according to the present disclosure and is executed by the image forming processing portion 32 of the control portion 21.

### <Step S14>

In Step S14, the control portion 21 causes the operation display portion 22 to display the acceptance screen.

### <Step S15>

In Step S15, the control portion 21 determines whether or not the reading operation has been accepted in the acceptance screen displayed on the operation display portion 22.

Herein, when determining that the reading operation has been accepted in the acceptance screen (Yes in S15), the control portion 21 shifts the processing to Step S16. On the other hand, when determining that the reading operation has not been accepted in the acceptance screen (No in S15), the control portion 21 stands by until the reading operation is accepted in the acceptance screen in Step S15.

It is noted that the control portion 21 may redo the processing of Step S13 when a predetermined operation is accepted in the acceptance screen.

### <Step S16>

In Step S16, the control portion 21 executes the reading processing. The processing of Step S16 is an example of a reading step according to the present disclosure and is executed by the reading processing portion 33 of the control portion 21.

It is noted that the control portion 21 may determine whether or not the image read by the reading processing is the adjustment image based on the execution result of the reading processing, and when it is determined that the read image is not the adjustment image, shift the processing to Step S14 instead of Step S17.

### <Step S17>

In Step S17, the control portion 21 transmits the execution result of the reading processing to the image forming apparatus 1, and causes the control portion 11 of the image forming apparatus 1 to execute the adjustment processing. The processing of Step S17 is an example of an adjustment step according to the present disclosure and is executed by the adjustment processing portion 34 of the control portion 21.

It is noted that the control portion 21 may transmit the adjustment image data to the image forming apparatus 1 after executing the processing of Step S17, and cause the control portion 11 of the image forming apparatus 1 to re-execute the adjustment image forming processing. In this case, the control portion 21 may set the voltage value of the driving voltage of each of the groups back to a value obtained before the execution of the first driving voltage adjustment processing in accordance with a predetermined cancel operation in the operation display portion 22.

In this manner, in the image forming system 100, the plurality of discharge elements 13H included in the line head 13A are used to form the monochrome image of black on the sheet conveyed by the sheet conveying portion 12. Further, the monochrome image of black formed on the sheet is read, and the driving voltage of the group is adjusted for each of the groups included in the line head 13A based on the read result. Thus, it is possible to suppress the variation of the ink discharge amounts in the plurality of discharge elements 13H included in the recording heads 13X.

Furthermore, in the image forming system 100, the rasterization processing is executed on the original image data to thus generate the adjustment image data. The original image data in the vector format has a smaller data amount than the adjustment image data in a bitmap format. Therefore, it is possible to set a storage capacity for storing data used for forming the adjustment image to be smaller than that of a configuration of storing the adjustment image data.

Further, in the image forming system 100, the image generation processing portion 31 is provided in the information processing apparatus 2 that is communicably connected to the image forming apparatus 1. Thus, one image generation processing portion 31 can be shared by a plurality of image forming apparatuses 1.

It is noted that each of the recording heads 13X may include the power supplies respectively corresponding to the discharge elements 13H included in the recording head 13X. In this case, the adjustment processing portion 34 only needs to adjust the driving voltage for each of the discharge elements 13H based on the adjustment image read by the reading processing portion 33.

Furthermore, in the image forming system 100, the image forming apparatus 1 may include the image reading portion 25, the image generation processing portion 31, the image forming processing portion 32, the reading processing portion 33, and the adjustment processing portion 34. The image forming apparatus 1 in this case is an example of an image forming system according to the present disclosure.

### Second Embodiment

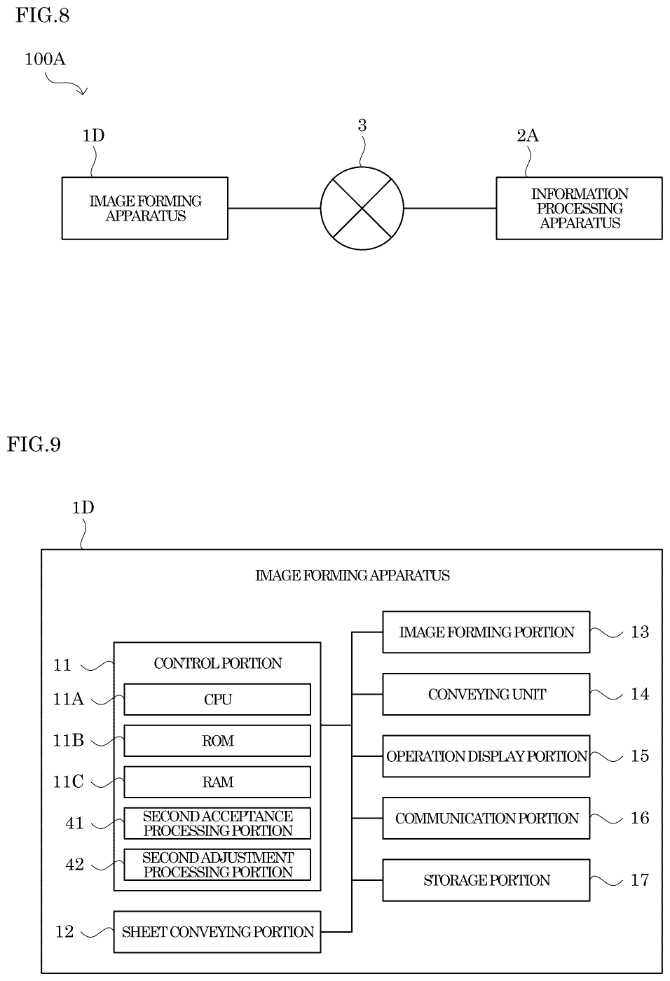

Hereinafter, a configuration of an image forming system 100A according to a second embodiment of the present disclosure will be described with reference to FIG. 8 to FIG. 10.

As shown in FIG. 1 and FIG. 8, the image forming system 100A differs from the image forming system 100 in that an image forming apparatus 1D and an information processing apparatus 2A are provided in place of the image forming apparatus 1 and the information processing apparatus 2. It is noted that other points are common in the image forming system 100 and the image forming system 100A. Hereinafter, descriptions will only be given on the points that differ from those of the image forming system 100 out of the configuration of the image forming system 100A.

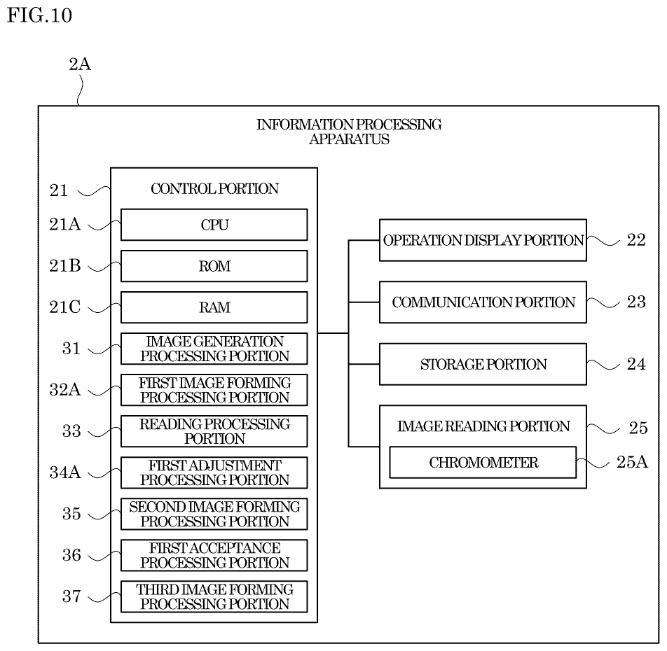

As shown in FIG. 6 and FIG. 10, the information processing apparatus 2A differs from the information processing apparatus 2 in that a first image forming processing portion 32A and a first adjustment processing portion 34A are provided in place of the image forming processing portion 32 and the adjustment processing portion 34. In addition, the information processing apparatus 2A differs from the information processing apparatus 2 in that a second image forming processing portion 35, a first acceptance processing portion 36, and a third image forming processing portion 37 are provided.

As shown in FIG. 2 and FIG. 9, the image forming apparatus 1D differs from the image forming apparatus 1 in that a second acceptance processing portion 41 and a second adjustment processing portion 42 are provided.

The first image forming processing portion 32A has the same function as the image forming processing portion 32.

The first adjustment processing portion 34A has the same function as the adjustment processing portion 34.

After the adjustment of the driving voltage by the first adjustment processing portion 34A, the second image forming processing portion 35 forms the adjustment image on the sheet conveyed by the sheet conveying portion 12 using the line heads 13A to 13D.

After the formation of the adjustment image by the second image forming processing portion 35, the first acceptance processing portion 36 accepts a selection operation to select either an end or continuance of the adjustment of the driving voltage.

For example, the first acceptance processing portion 36 causes the operation display portion 22 to display a selection operation acceptance screen and thus accepts the selection operation. The selection operation acceptance screen is a screen for accepting the selection operation. For example, the selection operation acceptance screen includes an operation key that is used to select an end of the adjustment of the driving voltage, an operation key that is used to select continuance of the adjustment of the driving voltage, and a message that prompts the user to perform the selection operation.

When the continuance of the adjustment of the driving voltage is selected by the selection operation, the third image forming processing portion 37 forms a manual adjustment image including a specific image formed by each of the groups on the sheet conveyed by the sheet conveying portion 12 using the line heads 13A to 13D.

The manual adjustment image includes a first manual adjustment image (an example of a manual adjustment image according to the present disclosure) constituted of the specific image formed by each of the groups included in the line head 13A.

The manual adjustment image also includes a second manual adjustment image constituted of the specific image formed by each of the groups included in the line head 13B.

The manual adjustment image also includes a third manual adjustment image constituted of the specific image formed by each of the groups included in the line head 13C.

The manual adjustment image also includes a fourth manual adjustment image constituted of the specific image formed by each of the groups included in the line head 13D.

The first manual adjustment image, the second manual adjustment image, the third manual adjustment image, and the fourth manual adjustment image have a common configuration except that the colors thereof differ.

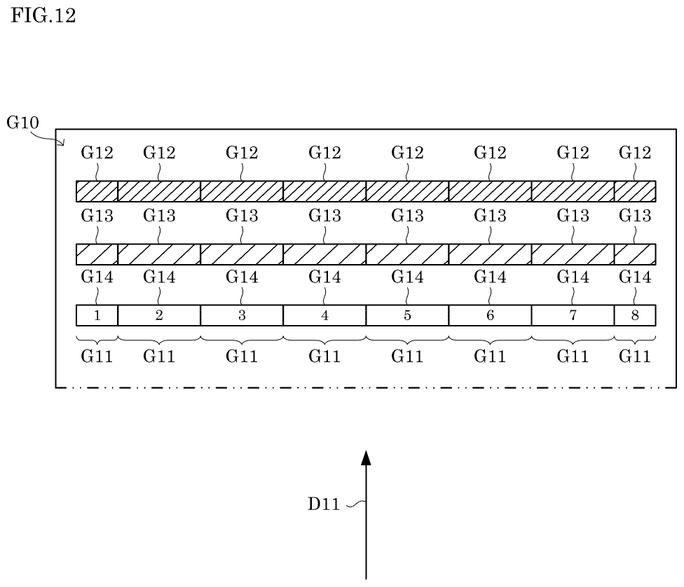

FIG. 12 shows a first manual adjustment image G10 as an example of the first manual adjustment image. FIG. 12 shows the first manual adjustment image G10 formed on a sheet.

As shown in FIG. 12, the first manual adjustment image G10 includes a plurality of specific images G11. The plurality of specific images G11 respectively correspond to the plurality of groups included in the line head 13A. For example, the line head 13A of the image forming apparatus 1D includes eight groups. Therefore, the first manual adjustment image G10 includes eight specific images G11 (see FIG. 12).

As shown in FIG. 12, each of the specific images G11 includes a first concentration check image G12 (an example of a concentration check image according to the present disclosure), a second concentration check image G13, and an identification image G14 that are aligned in the conveying direction D11. The first concentration check image G12 and the second concentration check image G13 are each a halftone image formed by using black ink, and are each a rectangular image. The second concentration check image G13 has a lower concentration than the first concentration check image G12. The identification image G14 is an image including identification information of the group. For example, in the image forming apparatus 1D, identification numbers of “1” to “8” are given to the eight groups included in the line head 13A. Therefore, each of the identification images G14 includes the identification number given to the corresponding group (see FIG. 12).

When the continuance of the adjustment of the driving voltage is selected by the selection operation, the second acceptance processing portion 41 accepts an adjustment operation of the driving voltage for each of the groups.

For example, the second acceptance processing portion 41 causes the operation display portion 15 to display a manual adjustment screen and thus accepts the adjustment operation. The manual adjustment screen is a screen for accepting the adjustment operation for each of the groups.

For example, the manual adjustment screen includes eight driving voltage adjustment columns respectively corresponding to the eight groups included in the line head 13A. In addition, the manual adjustment screen includes eight driving voltage adjustment columns respectively corresponding to the eight groups included in the line head 13B. In addition, the manual adjustment screen includes eight driving voltage adjustment columns respectively corresponding to the eight groups included in the line head 13C. In addition, the manual adjustment screen includes eight driving voltage adjustment columns respectively corresponding to the eight groups included in the line head 13D.

The identification number of the corresponding group is added in the vicinity of each of the driving voltage adjustment columns. Thus, the user can identify the group corresponding to the driving voltage adjustment column.

For example, in the image forming system 100A, the driving voltage can be designated in 10 levels from “1” to “10”. In this case, in each of the driving voltage adjustment columns, an input operation for inputting a numerical value of any of “1” to “10” (the adjustment operation) is accepted. It is noted that in each of the driving voltage adjustment columns, a numerical value indicating the driving voltage obtained after the adjustment by the first adjustment processing portion 34A is initially displayed.

The second adjustment processing portion 42 adjusts the driving voltage of each of the groups in accordance with the adjustment operation.

For example, the manual adjustment screen includes an operation end key. When a user operation with respect to the operation end key is accepted, the second adjustment processing portion 42 adjusts the driving voltage of each of the groups based on a display content of the manual adjustment screen at the time the operation to the operation end key is made.

### Second Driving Voltage Adjustment Processing

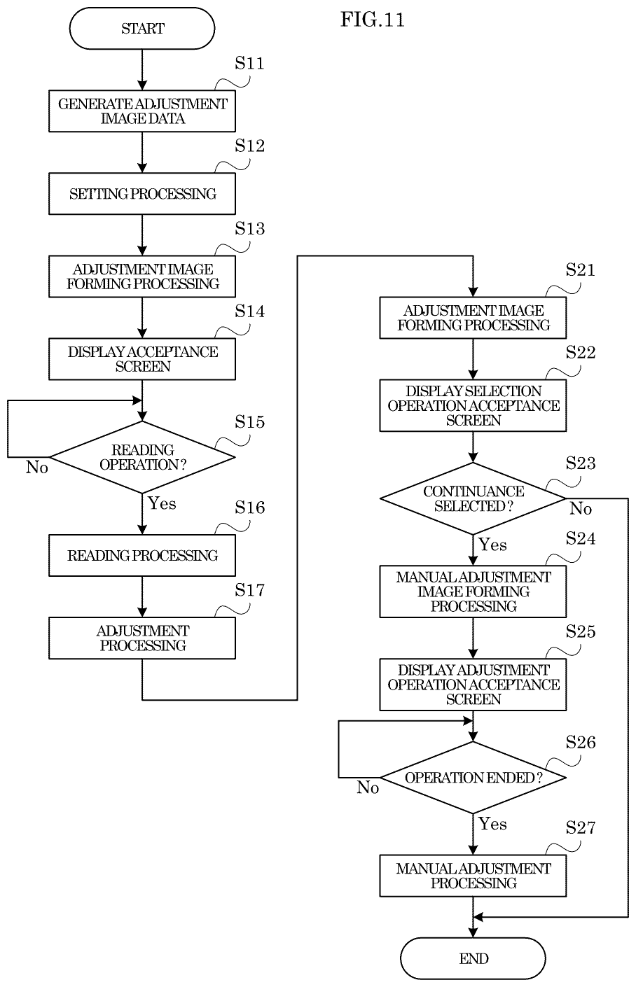

Hereinafter, exemplary procedures of second driving voltage adjustment processing executed by the control portion 21 of the information processing apparatus 2A and the control portion 11 of the image forming apparatus 1D in the image forming system 100A will be described with reference to FIG. 11. It is noted that the second driving voltage adjustment processing is executed when an operation that instructs execution of the second driving voltage adjustment processing is accepted in the operation display portion 22.

Of the second driving voltage adjustment processing, processing of Step S11 to Step S17 shown in FIG. 11 is the same as the processing of Step S11 to Step S17 in the first driving voltage adjustment processing (see FIG. 7).

### <Step S21>

In Step S21, similar to the processing of Step S13, the control portion 21 causes the control portion 11 of the image forming apparatus 1D to execute the adjustment image forming processing. The processing of Step S21 is executed by the second image forming processing portion 35 of the control portion 21.

Thus, the user can compare the adjustment image formed by the processing of Step S13 and the adjustment image formed by the processing of Step S21, and determine whether or not to manually adjust the driving voltage.

### <Step S22>

In Step S22, the control portion 21 causes the operation display portion 22 to display the selection operation acceptance screen. The processing of Step S22 is executed by the first acceptance processing portion 36 of the control portion 21.

### <Step S23>

In Step S23, the control portion 21 determines whether or not continuance of the adjustment of the driving voltage has been selected in the selection operation acceptance screen displayed on the operation display portion 22.

Herein, when determining that the continuance of the adjustment of the driving voltage has been selected in the selection operation acceptance screen (Yes in S23), the control portion 21 shifts the processing to Step S24. On the other hand, when determining that the end of the adjustment of the driving voltage has been selected in the selection operation acceptance screen (No in S23), the control portion 21 ends the second driving voltage adjustment processing.

### <Step S24>

In Step S24, the control portion 21 causes the control portion 11 of the image forming apparatus 1D to execute manual adjustment image forming processing for forming the manual adjustment image on the sheet conveyed by the sheet conveying portion 12. The processing of Step S24 is executed by the third image forming processing portion 37 of the control portion 21.

Thus, the user can determine whether or not the manual adjustment is necessary and the adjustment amount for each of the groups based on the manual adjustment image formed by the processing of Step S24.

### <Step S25>

In Step S25, the control portion 11 causes the operation display portion 15 to display the manual adjustment screen. The processing of Step S25 is executed by the second acceptance processing portion 41 of the control portion 11.

### <Step S26>

In Step S26, the control portion 11 determines whether or not the user operation in the manual adjustment screen displayed on the operation display portion 15 has ended.

Specifically, the control portion 11 determines that the user operation in the manual adjustment screen has ended when a user operation with respect to the operation end key included in the manual adjustment screen is accepted.

Herein, when determining that the user operation in the manual adjustment screen has ended (Yes in S26), the control portion 11 shifts the processing to Step S27. On the other hand, when determining that the user operation in the manual adjustment screen has not ended (No in S26), the control portion 11 stands by until the user operation in the manual adjustment screen ends in Step S26.

### <Step S27>

In Step S27, the control portion 11 executes manual adjustment processing for adjusting the driving voltage of each of the groups in accordance with the adjustment operation accepted while the manual adjustment screen has been displayed. The processing of Step S27 is executed by the second adjustment processing portion 42 of the control portion 11.

It is noted that the control portion 11 may re-execute the manual adjustment image forming processing after executing the processing of Step S27. In this case, the control portion 11 may re-execute the processing of Step S25 to Step S27 in accordance with the user operation in the operation display portion 15.

In this manner, in the image forming system 100A, an operation to manually adjust the driving voltage of each of the groups is accepted in accordance with the user operation after the driving voltage of each of the groups is adjusted automatically. Thus, the user can invoke the manual adjustment screen with a minimum operation when not being satisfied of the result of the automatic adjustment of the driving voltage of each of the groups (the processing of Step S17).

It is noted that the selection operation acceptance screen may be displayed on the operation display portion 15 of the image forming apparatus 1D.

Further, the adjustment operation acceptance screen may be displayed on the operation display portion 22 of the information processing apparatus 2A.

Furthermore, the processing of Step S24 may be omitted. In this case, the manual adjustment image may be formed in place of the adjustment image in the processing of Step S21.

Moreover, in the image forming system 100A, the image forming apparatus 1D may include the image reading portion 25, the image generation processing portion 31, the first image forming processing portion 32A, the reading processing portion 33, the first adjustment processing portion 34A, the second image forming processing portion 35, the first acceptance processing portion 36, and the third image forming processing portion 37.

Further, in the image forming system 100A, the information processing apparatus 2A may include the second acceptance processing portion 41 and the second adjustment processing portion 42.

### Notes of Disclosure

Hereinafter, a general outline of the disclosure extracted from the embodiments described above will be noted. It is noted that the respective configurations and processing functions described in the notes below can be sorted and arbitrarily combined as appropriate.

### <Note 1>

1. An image forming system, including: a sheet conveying portion which conveys a sheet; a plurality of nozzles arranged along a width direction orthogonal to a conveying direction of the sheet by the sheet conveying portion; discharge elements which are respectively provided in correspondence with the nozzles and cause ink to be discharged from the nozzles in accordance with an application of a driving voltage; an image forming processing portion which forms, using a plurality of the discharge elements, an adjustment image that is based on predetermined adjustment image data on the sheet conveyed by the sheet conveying portion; a reading processing portion which reads the adjustment image formed on the sheet; and an adjustment processing portion which adjusts the driving voltage for each of the discharge elements or in a unit of the plurality of discharge elements based on the adjustment image read by the reading processing portion.

### <Note 2>

The image forming system according to note 1, in which the adjustment image data is image data in a bitmap format, and the image forming system comprises an image generation processing portion which executes rasterization processing to generate the adjustment image data.

### <Note 3>

The image forming system according to note 2, including: an image forming apparatus including the sheet conveying portion, the plurality of nozzles, and the plurality of discharge elements; and an information processing apparatus which includes the image generation processing portion and is communicably connected to the image forming apparatus.

### <Note 4>

The image forming system according to any one of notes 1 to 3, in which the reading processing portion reads a color of the adjustment image formed on the sheet using a chromometer.

### <Note 5>

The image forming system according to any one of notes 1 to 4, in which the image forming processing portion is set as a first image forming processing portion, the adjustment processing portion is set as a first adjustment processing portion, the first adjustment processing portion adjusts the driving voltage for each group constituted of the plurality of discharge elements respectively corresponding to the plurality of nozzles that are consecutive along the width direction, and the image forming system includes: a second image forming processing portion which forms, after the adjustment of the driving voltage by the first adjustment processing portion, the adjustment image on the sheet conveyed by the sheet conveying portion using the plurality of discharge elements; a first acceptance processing portion which accepts, after the formation of the adjustment image by the second image forming processing portion, a selection operation to select either an end or continuance of the adjustment of the driving voltage; a second acceptance processing portion which accepts, when the continuance of the adjustment of the driving voltage is selected by the selection operation, an adjustment operation of the driving voltage for each of the groups; and a second adjustment processing portion which adjusts the driving voltage of each of the groups in accordance with the adjustment operation.

### <Note 6>

The image forming system according to note 5, including: a third image forming processing portion which forms, when the continuance of the adjustment of the driving voltage is selected by the selection operation, a manual adjustment image including a specific image formed by each of the groups on the sheet conveyed by the sheet conveying portion using the plurality of discharge elements, in which the specific image includes a concentration check image and identification information of the group, that are aligned in the conveying direction.

### <Note 7>

An adjustment method executed in an image forming system including a sheet conveying portion which conveys a sheet, a plurality of nozzles arranged along a width direction orthogonal to a conveying direction of the sheet by the sheet conveying portion, and discharge elements which are respectively provided in correspondence with the nozzles and cause ink to be discharged from the nozzles in accordance with an application of a driving voltage, the adjustment method including: an image forming step of forming, using a plurality of the discharge elements, an adjustment image that is based on predetermined adjustment image data on the sheet conveyed by the sheet conveying portion; a reading step of reading the adjustment image formed on the sheet; and an adjustment step of adjusting the driving voltage for each of the discharge elements or in a unit of the plurality of discharge elements based on the adjustment image read in the reading step.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming system, comprising:
a sheet conveying portion which conveys a sheet;
a plurality of nozzles arranged along a width direction orthogonal to a conveying direction of the sheet by the sheet conveying portion;
discharge elements which are respectively provided in correspondence with the nozzles and cause ink to be discharged from the nozzles in accordance with an application of a driving voltage;
an image forming processing portion which forms, using a plurality of the discharge elements, an adjustment image that is based on predetermined adjustment image data on the sheet conveyed by the sheet conveying portion;
a reading processing portion which reads the adjustment image formed on the sheet; and
an adjustment processing portion which adjusts the driving voltage for each of the discharge elements or in a unit of the plurality of discharge elements based on the adjustment image read by the reading processing portion.

2. The image forming system according to claim 1, wherein
the adjustment image data is image data in a bitmap format, and
the image forming system comprises an image generation processing portion which executes rasterization processing to generate the adjustment image data.

3. The image forming system according to claim 2, comprising:
an image forming apparatus including the sheet conveying portion, the plurality of nozzles, and the plurality of discharge elements; and
an information processing apparatus which includes the image generation processing portion and is communicably connected to the image forming apparatus.

4. The image forming system according to claim 1, wherein
the reading processing portion reads a color of the adjustment image formed on the sheet using a chromometer.

5. The image forming system according to claim 1, wherein
the image forming processing portion is set as a first image forming processing portion,
the adjustment processing portion is set as a first adjustment processing portion,
the first adjustment processing portion adjusts the driving voltage for each group constituted of the plurality of discharge elements respectively corresponding to the plurality of nozzles that are consecutive along the width direction, and
the image forming system comprises:
a second image forming processing portion which forms, after the adjustment of the driving voltage by the first adjustment processing portion, the adjustment image on the sheet conveyed by the sheet conveying portion using the plurality of discharge elements;
a first acceptance processing portion which accepts, after the formation of the adjustment image by the second image forming processing portion, a selection operation to select either an end or continuance of the adjustment of the driving voltage;
a second acceptance processing portion which accepts, when the continuance of the adjustment of the driving voltage is selected by the selection operation, an adjustment operation of the driving voltage for each of the groups; and
a second adjustment processing portion which adjusts the driving voltage of each of the groups in accordance with the adjustment operation.

6. The image forming system according to claim 5, comprising:
a third image forming processing portion which forms, when the continuance of the adjustment of the driving voltage is selected by the selection operation, a manual adjustment image including a specific image formed by each of the groups on the sheet conveyed by the sheet conveying portion using the plurality of discharge elements, wherein
the specific image includes a concentration check image and identification information of the group, that are aligned in the conveying direction.

7. An adjustment method executed in an image forming system including a sheet conveying portion which conveys a sheet, a plurality of nozzles arranged along a width direction orthogonal to a conveying direction of the sheet by the sheet conveying portion, and discharge elements which are respectively provided in correspondence with the nozzles and cause ink to be discharged from the nozzles in accordance with an application of a driving voltage, the adjustment method comprising:
an image forming step of forming, using a plurality of the discharge elements, an adjustment image that is based on predetermined adjustment image data on the sheet conveyed by the sheet conveying portion;
a reading step of reading the adjustment image formed on the sheet; and
an adjustment step of adjusting the driving voltage for each of the discharge elements or in a unit of the plurality of discharge elements based on the adjustment image read in the reading step.
